(19) United States
(12) Patent Application Publication
(10) Pub. No.: US 2026/0212336 A1
(43) Pub. Date: Jul. 23, 2026

(54) SYSTEMS AND METHODS FOR AUTONOMOUSLY TRANSITIONING RECURRING AUTOPAYMENT EVENTS BETWEEN PAYMENT ACCOUNTS

(71) Applicant: Wells Fargo Bank, N.A., San Francisco, CA (US)

(72) Inventors: Caleb Parker, Saint Charles, MO (US); Janet L. Koger-Nowlin, Charlotte, NC (US); Christopher J. Starr, Columbus, OH (US); Jeanette Imai, Saint Petersburg, FL (US)

(21) Appl. No.: 19/034,241

(22) Filed: Jan. 22, 2025

(51) Int. Cl. G06Q 20/10; G06Q 20/40; G06Q 40/02

(52) U.S. Cl. CPC G06Q 20/102; G06Q 20/401; G06Q 20/405; G06Q 40/02

(57) ABSTRACT

Systems, apparatuses, methods, and computer program products are disclosed for providing overdraft protection during transitions between payment accounts. An example method includes identifying a set of historical transactions associated with a legacy payment account of a user and deriving a set of recurring autopayment events from the set of historical transactions. The example method further includes executing a proactive protection protocol. The proactive protection protocol includes analyzing a new payment account, evaluating whether a deadline associated with the unscheduled recurring autopayment event falls within a predefined threshold time period, assessing whether the legacy payment account has sufficient funds to satisfy an upcoming payment, performing a proactive intervention operation to address the upcoming payment, scheduling any unscheduled recurring autopayment events as recurring autopayment events in the new payment account, and scheduling a temporary recurring digital payment from the new payment account to the legacy payment account.

### BACKGROUND

Recurring autopayment events, such as utility bills, subscriptions, and loan payments, simplify financial management by automating regular payments. These recurring autopayments are connected to a payment account and the user and thus, save the user's time and reduce the risk of missed payments. However, when a user transitions to a new payment account, the user must also migrate recurring autopayments to the new payment account. This can be a manually intensive, complex, and error-prone process.

### BRIEF SUMMARY

Conventionally, users must manually transition recurring autopayments from one payment account to another. This requires a user to manually identify all existing recurring payments, update the payment details for the payee account and/or within a legacy payment account and new payment account, and verify that the changes are correctly implemented. This process can be time-consuming for the user and can result in overlooked recurring autopayments and/or incorrectly input payment details. Such mistakes can result in missed payments that lead to service disruptions or cancellations and/or overdrafting of the legacy payment account that incur fees and/or penalties.

Furthermore, the user must manually verify whether a newly scheduled recurring autopayment in the new payment account is correctly configured. Typically, this requires the user to wait until the payment due date and log into an associate payee system to confirm the payment was successful. Such absence of real-time monitoring and/or verification of scheduled recurring autopayments exacerbates the risk of failed payments because users remain unaware of issues until they lead to financial penalties or service disruptions.

In contrast to these conventional techniques for transitioning from a legacy payment account to a new payment account, example embodiments described herein provide for autonomous and streamlined migration of recurring autopayment events in the new payment account. In particular, example embodiments described herein may automatically derive recurring autopayment events using a set of historical transactions from a legacy payment account. A proactive protection protocol may be executed to determine whether the derived recurring autopayment events have been scheduled as recurring autopayment events in the new payment account. Any unscheduled recurring autopayment events may be scheduled as recurring autopayment events in the new payment account. Thus, example embodiments autonomously identify recurring autopayment events and ensure the recurring autopayment events are scheduled with the new payment account without the need for manual intervention.

Additionally, example embodiments may evaluate whether any unscheduled recurring autopayment events are associated with a deadline that falls within a predefined threshold time period. If so, example embodiments may determine whether the legacy payment account has sufficient funds to satisfy the upcoming payment for the unscheduled recurring autopayment event. If the legacy payment account lacks sufficient funds, example embodiments may perform a proactive intervention operation to address the upcoming payment. A proactive intervention operation may include causing provision of a payment alert to the user, transferring a fund amount sufficient to satisfy the upcoming payment from the new payment account to the legacy payment account, and/or triggering a payment from the new payment account to satisfy the upcoming payment. Thus, example embodiments described herein provide for autonomous, time-sensitive issue detection and resolution for recurring autopayment events.

Example embodiments may further verify a scheduled recurring autopayment event to ensure that the parameters of the scheduled recurring autopayment event are correct. In particular, a test transaction may be initiated prior to a payment date. The results of the test transaction may be used to verify a scheduled recurring autopayment event. By verifying scheduled recurring autopayment events in advance of the payment deadlines, this allows users to intervene to correct and/or update information for scheduled recurring autopayment events, thereby reducing the risk of delayed or missed payments.

Additionally, example embodiments may automatically schedule a temporary recurring digital payment from the new payment account to the legacy payment account. The temporary recurring digital payment may serve as a failsafe for any unexpected and/or recurring autopayment events that are unable to be immediately transitioned to the new payment account. The legacy payment account may receive funds from the new payment account that can be used to cover the associated payments for such events and thereby prevent the legacy payment account from experiencing an overdraft.

Furthermore, example embodiments may monitor the new payment account over a watch period to ensure that the scheduled recurring payment events are configured appropriately. During the watch period, example embodiments may further access the legacy payment account to derive any new or missed recurring payment events. By monitoring both the new payment account and legacy payment account over the watch period, this helps ensure that less frequent or irregular recurring payment events are derived and transitioned to the new payment account. Thus, example embodiments provide for real-time oversight and resolution capabilities.

Accordingly, the present disclosure sets forth systems, methods, and apparatuses to provide a streamlined and efficient transition of recurring autopayment events from a legacy payment account to a new payment account. There are many advantages of these and other embodiments described herein. For instance, in contrast to conventional transitioning methods that rely solely on user input to create recurring autopayment events in the new payment account, example embodiments described herein execute various transition operations autonomously with minimal to no user interaction. For example, example embodiments may automatically derive recurring autopayment events for a legacy payment account without requiring the user to explicitly identify such events. Furthermore, example embodiments may automatically identify parameters for recurring autopayment events based on associated historical transactions. These parameters may be evaluated to automatically identify time-sensitive unscheduled recurring autopayment events and perform proactive intervention operations to address the upcoming payment and prevent service delays and/or penalties.

Furthermore, in contrast to conventional methods that fail to provide any assurances of autopayment configuration, example embodiments provide for automatic verification of scheduled recurring autopayment events to ensure that the scheduled recurring autopayment event is correctly configured and, thus, avoid unforeseen delays and/or payment issues. Furthermore, this effectively improves the efficiency of computer systems by proactively addressing any issues prior to the payment due date, thereby eliminating the need for computational resources dedicated to fixing such payment issues after they occur.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used autonomously managing overdraft protection during transitions between payment accounts.

FIG. 2 illustrates a schematic block diagram of example circuitry embodying a system device that may perform various operations, in accordance with some example embodiments described herein.

FIG. 3 illustrates an example flowchart for providing overdraft protection during a transitionary period, in accordance with some example embodiments described herein.

FIG. 4 illustrates an example flowchart for generating a set of historical transactions, in accordance with some example embodiments described herein.

FIG. 5 illustrates an example flowchart for executing a proactive protection protocol, in accordance with some example embodiments described herein.

FIG. 6 illustrates an example transition dashboard that is used in some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers, programmable automation controllers, industrial computers, desktop computers, personal data assistants, laptop computers, tablet computers, smartbooks, palm-top computers, personal computers, smartphones, wearable devices (such as headsets, smartwatches, or the like), and similar electronic devices equipped with at least a processor and any other physical components necessary to perform the various operations described herein. Devices such as smartphones, laptop computers, tablet computers, and wearable devices are generally collectively referred to as “mobile devices.”

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

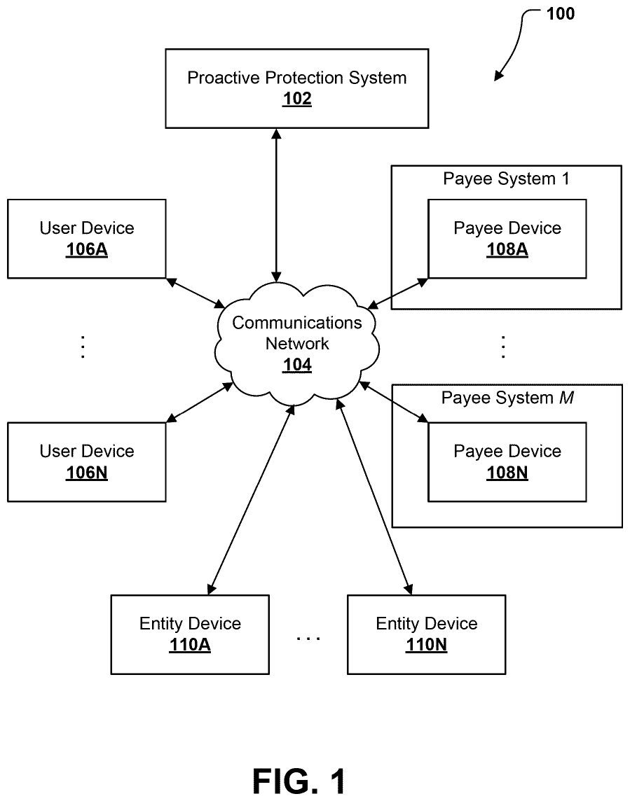

Example embodiments described herein may be implemented using any of a variety of computing devices or servers. To this end, FIG. 1 illustrates an example environment 100 within which various embodiments may operate. As illustrated, a proactive protection system 102 may receive and/or transmit information via communications network 104 (e.g., the Internet) with any number of other devices, such as one or more of user devices 106A-106N, payee devices 108A-108N, and/or entity devices 110A-110N.

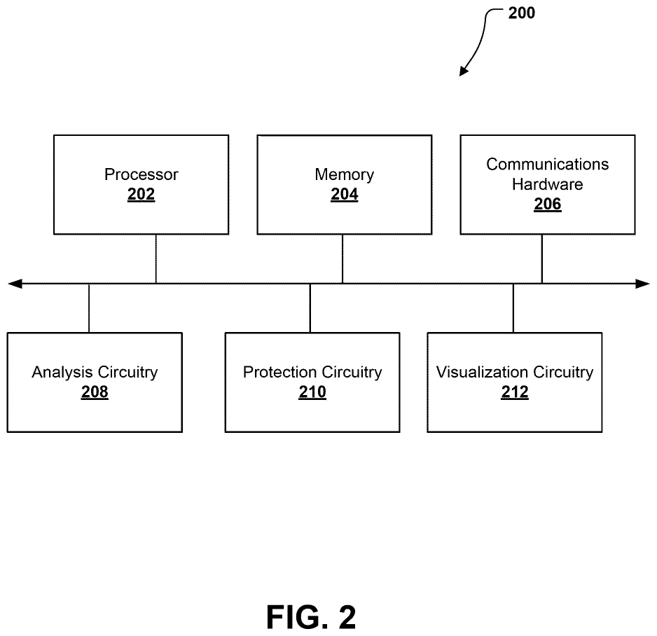

The proactive protection system 102 may be implemented as one or more computing devices or servers, which may be composed of a series of components. Particular components of the proactive protection system 102 are described in greater detail below with reference to apparatus 200 in connection with FIG. 2.

In some embodiments, the proactive protection system 102 further includes a storage device that comprises a distinct component from other components of the proactive protection system 102. The storage device may be embodied as one or more direct-attached storage devices (such as hard drives, solid-state drives, optical disc drives, or the like) or may alternatively comprise one or more network-attached storage devices independently connected to a communications network (e.g., communications network 104). The storage device may host the software executed to operate the proactive protection system 102. The storage device may store information relied upon during operation of the proactive protection system 102, such as various historical transactions that may be used by the proactive protection system 102, data and documents to be analyzed using the proactive protection system 102, or the like. In addition, the storage device may store control signals, device characteristics, and access credentials enabling interaction between the proactive protection system 102 and one or more of the user devices 106A-106N, payee devices 108A-108N, and/or entity devices 110A-110N.

The one or more user devices 106A-106N, the one or more payee devices 108A-108N, and the one or more entity devices 110A-110N may be embodied by any computing devices known in the art. The one or more user devices 106A-106N, the one or more payee devices 108A-108N, and the one or more entity devices 110A-110N need not themselves be independent devices but may be peripheral devices communicatively coupled to other computing devices. In some embodiments, a user device (e.g., any one of user devices 106A-106N) may be associated with a user who is associated with a new payment account maintained by the proactive protection system 102 (e.g., a customer). In some embodiments, a payee device (e.g., any one of payee devices 108A-108N) may be associated with a payee system with whom the user has an associated user account. A payee system may refer to a user, company, organization, and/or the like. In some embodiments, a payee may provide one or more goods and/or services to the user in exchange for payment. In some embodiments, an entity device (e.g., any one of entity devices 110A-110N) may be associated with a financial institution that maintains (or previously maintained) the legacy payment account.

Although FIG. 1 illustrates an environment and implementation in which the proactive protection system 102 interacts indirectly with a user via one or more of user devices 106A-106N, payee devices 108A-108N, and/or entity devices 110A-110N, in some embodiments, users may directly interact with the proactive protection system 102 (e.g., via communications hardware of the proactive protection system 102), in which case separate user devices 106A-106N, payee devices 108A-108N, and/or entity devices 110A-110N may not be utilized. Whether by way of direct interaction or indirect interaction via another device, a user may communicate with, operate, control, modify, or otherwise interact with the proactive protection system 102 to perform the various functions and achieve the various benefits described herein.

### Example Implementing Apparatuses

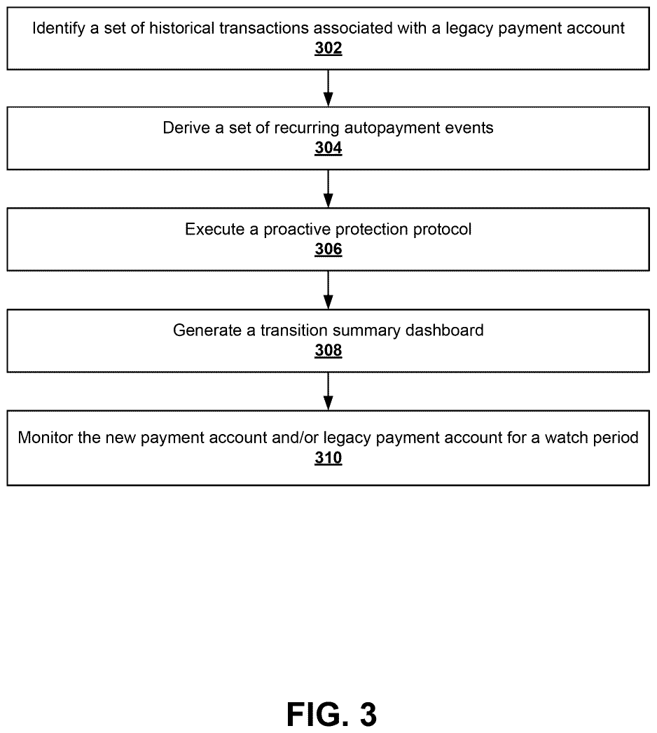

The proactive protection system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-5. As illustrated in FIG. 2, the apparatus 200 may include a processor 202, a memory 204, a communications hardware 206, a analysis circuitry 208, a protection circuitry 210, and a visualization circuitry 212, each of which will be described in greater detail below.

The processor 202 (and/or co-processor or any other processor assisting or otherwise associated with the processor) may be in communication with the memory 204 via a bus for passing information among components of the apparatus 200. The processor 202 may be embodied in a number of different ways and may, for example, include one or more processing devices configured to perform independently. Furthermore, the processor 202 may include one or more processors configured in tandem via a bus to enable independent execution of software instructions, pipelining, and/or multithreading. The use of the term “processor” may be understood to include a single-core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor 202 may be configured to execute hard-coded functionality. As such, whether configured by hardware or software methods, or by a combination of hardware with software, the processor 202 represents an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, software instructions, or the like for enabling the apparatus 200 to carry out various functions in accordance with example embodiments contemplated herein.

The communications hardware 206 may be any means, such as a device or circuitry embodied in either hardware or a combination of hardware and software, that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of a user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., the memory 204) accessible to the processor 202.

In addition, the apparatus 200 further comprises the analysis circuitry 208, which may be configured to identify a set of historical transactions associated with a legacy payment account and derive a set of recurring autopayment events from a set of historical transactions. In some embodiments, the analysis circuitry 208 may further extract individual historical transactions from a set of payment statements. The analysis circuitry 208 may utilize the processor 202, the memory 204, or any other hardware component included in the apparatus 200 to perform these operations, as described in connection with FIGS. 3-5 below. The analysis circuitry 208 may further utilize the communications hardware 206 to gather data from a variety of sources (e.g., any one of user devices 106A-106N, payee devices 108A-108N, and/or entity devices 110A-110N, as shown in FIG. 1) and/or exchange data with a user.

In addition, the apparatus 200 further comprises the protection circuitry 210, which may be configured to execute a proactive protection protocol. In some embodiments, the protection circuitry 210 may be configured to analyze a new payment account to determine whether each recurring autopayment event corresponds to a scheduled recurring autopayment event in the new payment account, evaluating whether a deadline associated with an unscheduled recurring autopayment event falls within a predefined threshold time period, assessing whether the legacy payment has sufficient funds to satisfy an upcoming payment associated with an unscheduled recurring autopayment event, automatically performing a proactive intervention operation to address an upcoming payment, scheduling any unscheduled recurring autopayment events, and/or scheduling a temporary recurring digital payment from the new payment account to the legacy payment account. In some embodiments, the protection circuitry 210 may be configured to cause provision of a payment alert to the user, transfer a fund amount sufficient to satisfy an upcoming payment associated with an unscheduled recurring autopayment event from the new payment account to the legacy payment account, and/or trigger a payment from the new payment account to satisfy the upcoming payment associated with the unscheduled recurring autopayment event. In some embodiments, the protection circuitry 210 may further verify a scheduled recurring autopayment event. In some embodiments, the protection circuitry 210 may further monitor the new payment account and/or legacy payment account for a watch period. The protection circuitry 210 may utilize the processor 202, the memory 204, or any other hardware component included in the apparatus 200 to perform these operations, as described in connection with FIGS. 3-5 below. The protection circuitry 210 may further utilize the communications hardware 206 to gather data from a variety of sources (e.g., any one of user devices 106A-106N, payee devices 108A-108N, and/or entity devices 110A-110N, as shown in FIG. 1) and/or exchange data with a user.

Further, the apparatus 200 further comprises the visualization circuitry 212, which may be configured to generate a transition summary board. The visualization circuitry 212 may utilize the processor 202, the memory 204, or any other hardware component included in the apparatus 200 to perform these operations, as described in connection with FIGS. 3-5 below. The visualization circuitry 212 may further utilize the communications hardware 206 to gather data from a variety of sources (e.g., any one of user devices 106A-106N, payee devices 108A-108N, and/or entity devices 110A-110N, as shown in FIG. 1) and/or exchange data with a user.

Although components 202-212 are described in part using functional language, it will be understood that the particular implementations necessarily include the use of particular hardware. It should also be understood that certain of these components 202-212 may include similar or common hardware. For example, the analysis circuitry 208, the protection circuitry 210, and the visualization circuitry 212 may each at times leverage use of the processor 202, the memory 204, or the communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus 200 therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the analysis circuitry 208, the protection circuitry 210, and the visualization circuitry 212 may leverage the processor 202, the memory 204, or the communications hardware 206, as described above, it will be understood that any of analysis circuitry 208, the protection circuitry 210, and the visualization circuitry 212 may include one or more dedicated processors, specially configured field programmable gate array, or application-specific interface circuit to perform its corresponding functions and may accordingly leverage the processor 202 executing software stored in a memory (e.g., the memory 204) or the communications hardware 206 for enabling any functions not performed by special-purpose hardware. In all embodiments, however, it will be understood that the analysis circuitry 208, the protection circuitry 210, and the visualization circuitry 212 comprise particular machinery designed for performing the functions described herein in connection with such elements of the apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third-party circuitry. For example, a given apparatus 200 may access one or more third-party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., the memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by the apparatus 200, as described in FIG. 2, that loading the software instructions onto a computing device or apparatus produces a special-purpose machine comprising the means for implementing various functions described herein.

Having described specific components of example apparatus 200, example embodiments are described below in connection with a series of graphical user interfaces (each, a GUI) and flowcharts.

### Example Operations

Turning to FIGS. 3-5, example flowcharts are illustrated that contain example operations implemented by example embodiments described herein. The operations illustrated in FIGS. 3-5 may, for example, be performed by the proactive protection system 102 shown in FIG. 1, which may in turn be embodied by an apparatus 200, which is shown and described in connection with FIG. 2. To perform the operations described below, the apparatus 200 may utilize one or more of the processor 202, the memory 204, the communications hardware 206, the analysis circuitry 208, the protection circuitry 210, the visualization circuitry 212, and/or any combination thereof. It will be understood that user interaction with the proactive protection system 102 may occur directly via the communications hardware 206 or may instead be facilitated by a separate user device (e.g., any one of user devices 106A-106N), as shown in FIG. 1, and may have similar or equivalent physical componentry facilitating such user interaction.

Turning first to FIG. 3, example operations are shown for providing overdraft protection during a transitionary period. A user who has opened a new payment account with a financial institution may still have one or more legacy payment accounts that are associated with the same financial institution or another financial institution. However, the legacy payment account may be used for and/or linked to recurring autopayment events. While the user may schedule new recurring autopayment events with the new payment account, this process is very manual and error prone. If the user misses a recurring autopayment event that is still linked to the legacy payment account, this can result in an overdraft of the legacy payment account that results in incurred fees and/or penalties. Furthermore, even with limited available overdraft funds, these funds may be insufficient to cover the cost of the recurring autopayment event and result in canceled or delayed services. A user is most likely to miss recurring autopayment events during a transitionary period between when the user opens a new payment account and ceases to actively use and/or close the legacy payment account. Example embodiments provide overdraft protection during such a transitionary period and, thus, proactively avoid missing recurring autopayment events.

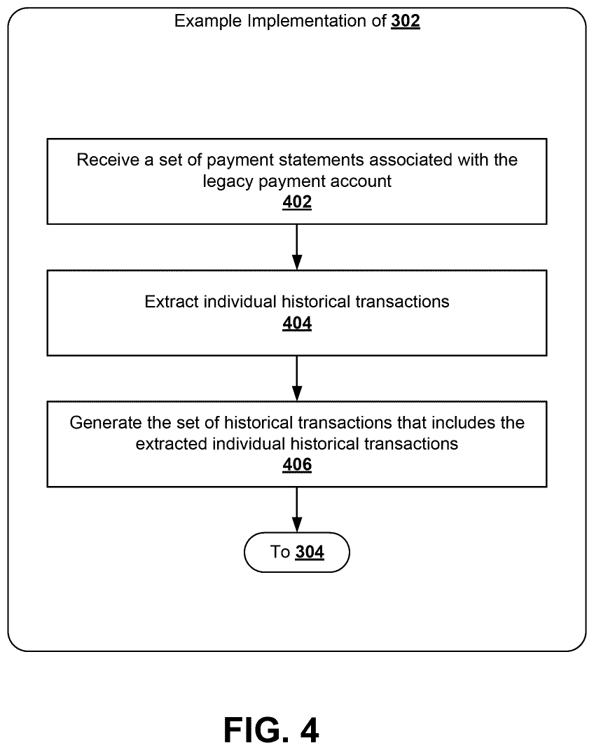

As shown by operation 302, the apparatus 200 includes means, such as the memory 204, the communications hardware 206, the analysis circuitry 208, or the like, for identifying a set of historical transactions associated with a legacy payment account. A legacy payment account may refer to a financial account that the user no longer actively uses or is planning to transition away from and/or close. However, the legacy payment account may be used for and/or linked to recurring autopayment events. The analysis circuitry 208 may first identify the set of historical transactions associated with a legacy payment. As described in more detail in operation 304, the set of historical transactions may be used to derive recurring autopayment events associated with the legacy payment account. The set of historical transactions may include one or more historical transactions. Each historical transactions may be associated with values for a given transaction attribute. As described in more detail in FIG. 4, the set of historical transactions may be identified from payment statements that are associated with the legacy payment account. Individual historical transactions may be extracted from the payment statements and may be used to generate the set of historical transactions. The generated set of historical transactions may be stored in an associated memory, such as the memory 204. The analysis circuitry 208 may be configured to identify the set of historical transactions associated with the legacy payment account from the stored set of historical transactions.

In some embodiments, operation 302 may be performed in accordance with the operations described by FIG. 4. Turning now to FIG. 4, example operations are shown for generating a set of historical transactions.

As shown by operation 402, the apparatus 200 includes means, such as the communications hardware 206, the analysis circuitry 208, or the like, for receiving a set of payment statements associated with the legacy payment account. In some embodiments, the user may use a user device (e.g., any one of user devices 106A-106N) to upload, transmit, or otherwise provide the communications hardware 206 with one or more payment statements. In some embodiments, the user may log into the new payment account via a mobile application, native application, web browser, portal, and/or the like. Upon successful authentication, the user may navigate the page and/or application to interact with a payment account transition assistance tool. Interaction with the payment account transition assistance tool may cause initiation of the processes and/or operations described in FIGS. 3-5. In some embodiments, the payment account transition assistance tool may request that the user upload payment statements from the legacy payment account over a defined time frame. For example, the payment account transition assistance tool may request the user upload all payment statements from the legacy payment account over the last year. The defined time frame may be any suitable time frame, such as the past three months, past six months, past year, etc.

In some embodiments, the payment account transition assistance tool may also allow the user to link the new payment account with the legacy payment account. This may allow the analysis circuitry 208 to use the communications hardware 206 to automatically request payment statements from an entity device (e.g., any one of entity devices 110A-110N). For example, the analysis circuitry 208 may use the communications hardware 206 to request payment statements from the entity device 110A for the legacy payment account over the defined time frame (e.g., three months, six months, one year). In some embodiments, the communications hardware 206 may use various application programming interfaces (each, an API) to connect to an entity device. This may require the user to provide associated credentials for the legacy payment account.

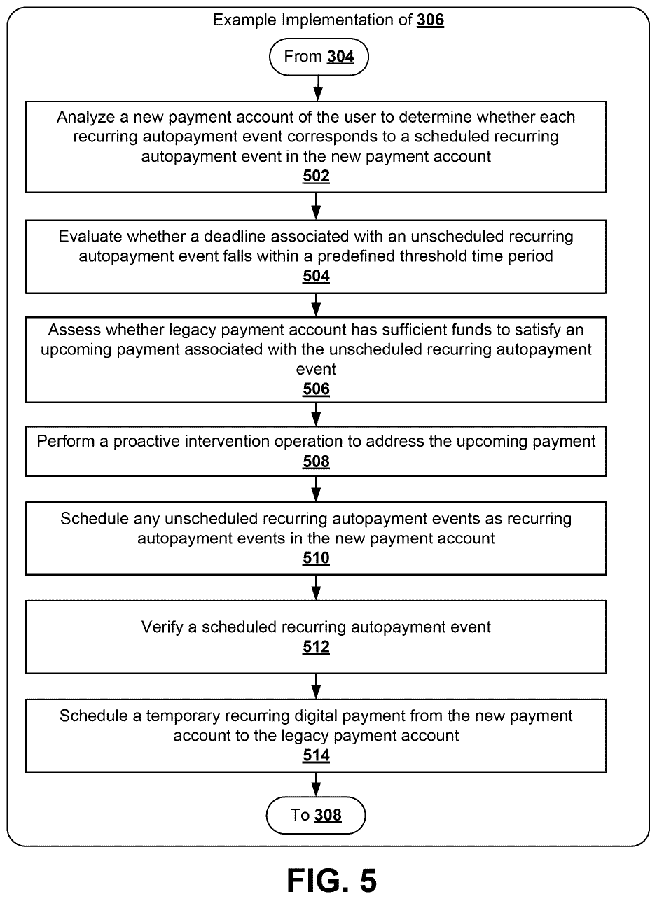

The communications hardware 206 may use the API service to perform an API call to fetch the legacy payment account information. The recipient entity device may provide a token to the communications hardware 206 using the API service. The communications hardware 206 may store the token either temporarily for one-time use or persistently for long-term use. The token may represent the legacy payment account, and the communications hardware 206 may simply provide the token in subsequent API calls to the entity device without the need for the legacy payment account credentials. The user may select whether to grant temporary, one-time access to the new payment account or long-term access. If one-time access is granted, the analysis circuitry 208 may use the communications hardware 206 to request the payment statements over the predefined time period using the token, as described above. However, the communications hardware 206 may not be provided subsequent access to the legacy payment account after the request for payment statements. If long-term access is granted, the analysis circuitry 208 may use the communications hardware 206 to request the payment statements over the predefined time period using the token. The token may be stored in an associated memory, such as the memory 204, and may be used to access the legacy payment account for additional operations. For example, as further detailed in FIG. 5, the token may be used to assess the amount of funds available in the legacy payment account.

A payment statement may be in any suitable structured format. For example, a payment statement may be formatted as a comma-separated value (CSV), extensible markup language (XML), open financial exchange (OFX), and/or the like. In some embodiments, a payment statement may be unformatted. For example, a user may scan a printed payment statement and submit the scanned image as a payment statement. As another example, the payment statement may be a portable document format (PDF). In some embodiments, different payment statements within the set of payment statements may be formatted differently.

As shown by operation 404, the apparatus 200 includes means, such the analysis circuitry 208 or the like, for extracting individual historical transactions. Once the communications hardware 206 has received the set of payment statements associated with the legacy payment account, the analysis circuitry 208 may process each payment statement to extract individual historical transactions. The analysis circuitry 208 may process each payment statement based on the format of the payment statement. For structured payment statements (e.g., CSV, XML, OFX), the analysis circuitry 208 may directly map data elements of the payment statement to predefined transaction attributes. In some embodiments, the mapping is performed using keywords matching. For unstructured payment statements (e.g., PDFs and images), the analysis circuitry 208 may first perform optical character recognition and/or natural language processing techniques to convert raw data into a structured format. The analysis circuitry 208 may then similarly map the data elements of the converted payment statement to predefined transaction attributes. The resulting individual historical transactions may be associated with a value for one or more transaction attributes.

A transaction attribute may define a characteristic or property that pertains to a particular historical transaction. In some embodiments, a transaction attribute may refer to a transaction date, a transaction time, a payment amount, a payee identifier, a payee name, a transaction description, a transaction type, a subcategory type, a payment method, an account number (e.g., legacy payment account number), a transaction identifier, an associated user account identifier (e.g., user account number in payee system), and/or the like. The analysis circuitry 208 may process a payment statement to identify a value for one or more of the transaction attributes for a given historical transaction. For example, an individual historical transaction may be associated with a transaction date of Nov. 1, 2023, a transaction time of 12:30 p.m. Eastern, a payment amount of $100.00, a payee identifier of “123456,” a payee name of “Utility Company X,” a transaction type of “recurring payment,” a subcategory type of “electricity payment,” a payment method of “ACH,” an account number of “123456,” and a transaction identifier of “xyz123abc.” In some embodiments, the payee identifier may be a routing number and/or an account number associated with the payee system and/or payee device (e.g., any one of payee devices 108A-108N). In some embodiments, individual historical transactions may not include a payee identifier.

In some embodiments, once the analysis circuitry 208 has analyzed each payment statement in the set of payment statements and extracted the individual historical transactions, the analysis circuitry 208 may perform post-processing operations on the individual historical transactions. In particular, the analysis circuitry 208 may apply filtering to the individual historical transactions. The analysis circuitry 208 may apply filtering to exclude duplicate records. For example, the analysis circuitry 208 may leverage values for relevant transaction attributes, such as the transaction identifier, to determine whether two historical transactions are the same. The analysis circuitry 208 may delete any duplicate historical transactions, thus ensuring that the generated set of historical transactions does not include duplicates.

As shown by operation 406, the apparatus 200 includes means, such the memory 204, the analysis circuitry 208, or the like, for generating the set of historical transactions that includes the extracted individual historical transactions. Once the analysis circuitry 208 has extracted the individual historical transactions and has performed any necessary post-processing operations, the analysis circuitry 208 may generate the set of historical transactions. The set of historical transactions may include the one or more individual historical transactions that were extracted from the payment statements. Duplicate historical transactions are removed during the post-processing operations and are therefore not included in the set of historical transactions.

The analysis circuitry 208 may store the set of historical transactions in an associated memory, such as the memory 204. Once generated, the analysis circuitry 208 may identify the set of historical transactions from the memory 204. The stored set of historical transactions may be associated with the particular legacy payment account of the user. For example, the account number attribute value associated with the legacy payment account may be associated with the set of historical transactions. Thus, overdraft protection may be provided for multiple legacy payment accounts.

In some embodiments, the communications hardware 206 may receive subsequent additional payment statements associated with the legacy payment account. In such an instance, the analysis circuitry 208 may perform operations 402-404 in a similar manner as described above. The analysis circuitry 208 may identify that the newly received additional payment statements are associated with a legacy payment account with an existing set of historical transactions and, thus, may instead update the existing set of historical transactions. In some embodiments, the analysis circuitry 208 may perform post-processing operations during the updating of the set of historical transactions instead of or in addition to the post-processing operations of operation 404. Thus, if a newly extracted individual historical transaction is a duplicate of an existing historical transaction currently in the set of historical transactions, it is not added to the set. This ensures that the set of historical transactions remains free of duplicate historical transactions.

Returning now to FIG. 3, as shown by operation 304, the apparatus 200 includes means, such as the analysis circuitry 208 or the like, for deriving a set of recurring autopayment events. The analysis circuitry 208 may derive a set of recurring autopayment events using the set of historical transactions associated with a legacy payment account. The set of recurring autopayment events may include one or more recurring autopayment events. A recurring autopayment event may refer to a scheduled payment that is performed automatically without manual user intervention. A recurring autopayment event may be associated with historical transactions that occur in regular intervals (e.g., weekly, monthly, annually), designate a consistent payee, and have a relatively stable payment amount. A recurring autopayment event may be associated with a service, subscription, or other obligation that requires periodic payments.

To derive a recurring autopayment event, the analysis circuitry 208 may identify recurring patterns that are indicative of a recurring autopayment event set up within the legacy payment account. To do so, the analysis circuitry 208 may use the set of historical transactions. In some embodiments, the analysis circuitry 208 may be configured with a rule set that defines the conditions for deriving a recurring autopayment event. The ruleset may describe rules and/or requirements that must be satisfied for a recurring autopayment event to be derived.

In particular, the analysis circuitry 208 may analyze the attribute values of the historical transactions to identify recurring patterns that may be indicative of a recurring autopayment event. The ruleset may direct the analysis circuitry 208 to examine historical transactions to identify historical transactions with matching payee identifier and/or payee name attribute values. For example, six historical transactions may each be associated with a payee name attribute of “Utility Company X.”

The ruleset may further direct the analysis circuitry 208 to determine whether these historical transactions occur within regular or periodic intervals of one another and/or occur on similar days and/or times using the transaction date attribute values and/or transaction time attribute values. By way of continuing example, each of the six historical transactions may occur on the first of the month. Additionally, or alternatively, the analysis circuitry 208 may perform logical and/or mathematical operations to determine a time interval between two temporally consecutive historical transactions. For example, the analysis circuitry 208 may determine the interval of time between a first historical transaction associated with a transaction date attribute of Feb. 1, 2023, and a second historical transaction date attribute of Mar. 1, 2023, is 28 days (inclusive of the first day). The analysis circuitry 208 may further determine the interval of time between the second historical transaction associated with a transaction date attribute of Mar. 1, 2023, and a third historical transaction date attribute of Apr. 1, 2023, is 31 days (inclusive of the first and last day). In some embodiments, the analysis circuitry 208 may verify that intervals of time between temporally consecutive historical transactions are within a predefined date threshold of one another. For example, a predefined date threshold may be three days. The analysis circuitry 208 may determine that the 28-day interval of time is within three days of the 31-day interval of time, and therefore, the predefined date threshold is satisfied. Thus, the historical transactions are within regular or periodic intervals of one another. This may be repeated for each of the six historical transactions.

The ruleset may further direct the analysis circuitry 208 to verify that the transaction amounts remain within a predefined variance threshold from one another. By way of continuing example, the six historical transactions may be associated with payment amount attribute values of $90.00, $90.00, $90.00, $90.00, $100.00, and $100.00. A predefined variance threshold may allow for up to a 15% variance, and thus, the analysis circuitry 208 may determine the transaction amounts satisfy the predefined variance threshold. Therefore, the analysis circuitry 208 may successfully verify that the transaction amounts are within a predefined variance threshold. If each of the rules in the ruleset are satisfied, the analysis circuitry 208 may derive a recurring autopayment event. The recurring autopayment event may be associated with the identified historical transactions (e.g., the six historical transactions that are associated with the common payee name attribute, determined to occur on the same day or within regular or periodic intervals of one another, and associated with transaction amount attributes that are verified to be within a predefined variance tolerance of one another).

The analysis circuitry 208 may further derive parameters for a recurring autopayment event. Recurring autopayment event parameters may include a payee identifier, a payee name, an average payment amount, a payment amount, a payment frequency, a payment consistency category (e.g., consistent or varied payments), and/or a predicted upcoming payment date. Some parameter values may be derived based on the analysis of the relevant historical transactions. By way of continuing example, the analysis circuitry 208 may derive a value of “Utility Company X” for the payee name and a value of “123456” for the payee identifier. The analysis circuitry 208 may perform additional mathematical and/or logical operations to determine some parameters. In particular, the analysis circuitry 208 may take the average of each of the payment amount attribute values to determine an average payment amount. By way of continuing example, the analysis circuitry 208 may derive a value of $93.33 for the average payment amount. The analysis circuitry 208 may further determine whether the payment amounts across each of the historical transactions are consistent (e.g., the same payment amount for each historical transaction) or varied (e.g., a different payment amount for each historical transaction). By way of continuing example, the analysis circuitry 208 may determine a varied consistency category. Additionally, if the historical transactions occur on similar days, the analysis circuitry 208 may determine the predicted upcoming payment date based on the next deadline for the particular date. By way of continuing example, the analysis circuitry 208 may derive a value of the first of the next month as the predicted upcoming payment date. If the historical transactions occur on different days, the analysis circuitry 208 may determine an average periodic interval between each of the historical transactions. The analysis circuitry 208 may derive a value for the payment frequency based on the average periodic interval. The analysis circuitry 208 may derive a value for the predicted upcoming payment date based on the average periodic interval and transaction date attribute of the most-recent historical transaction.

In some embodiments, the analysis circuitry 208 may additionally, or alternatively, derive a recurring payment event using a merchant directory. The analysis circuitry 208 may use the merchant directory to both identify less-frequent recurring autopayment events and/or validate derived recurring autopayment events. A merchant directory may store information pertaining to different merchants (e.g., payees). In some embodiments, a merchant directory may include an associated merchant identifier for the merchant, a merchant name, transaction metadata (e.g., merchant category code, associated location, accepted payment methods or preferences), and/or a merchant category. In some embodiments, the merchant category may be indicative of whether a particular merchant (e.g., payee) offers recurring services and/or a subscription-based model.

Certain recurring autopayment events may be less frequent than others. For example, a particular recurring autopayment event may be an annual subscription, and therefore, only one payment statement over a year-long period may reflect a payment for the recurring autopayment event. The analysis circuitry 208 may use the merchant directory to identify and derive a recurring autopayment event for these less-frequently occurring recurring autopayment events. In particular, the analysis circuitry 208 may access the merchant directory to identify whether a payee identifier and/or payee name associated with a historical transaction matches a merchant identifier included in the merchant directory. If so, the analysis circuitry 208 may further determine whether the associated merchant offers recurring services and/or uses a subscription-based model. If the analysis circuitry 208 determines the associated merchant is associated with recurring services and/or uses a subscription-based model, the analysis circuitry 208 may determine a recurring autopayment event even if only one associated historical transaction exists. The analysis circuitry 208 may derive the parameters for the recurring autopayment event based on the associated historical transactions in a similar manner as described above.

Additionally, or alternatively, the analysis circuitry 208 may validate the derived recurring autopayment events using the merchant directory. In particular, the analysis circuitry 208 may determine whether the payee identifier and/or payee name associated with a derived recurring autopayment event matches a merchant identifier included in the merchant directory. If so, the analysis circuitry 208 may determine whether the associated merchant is associated with recurring services and/or uses a subscription-based model. The analysis circuitry 208 may validate the recurring autopayment event if the merchant is associated with recurring services and/or uses a subscription-based model. In some embodiments, a derived recurring autopayment event that has been validated using the merchant directory may be associated with an increased confidence in the probability that the recurring autopayment event has been successfully derived.

As shown by operation 306, the apparatus 200 includes means, such as the memory 204, the communications hardware 206, the protection circuitry 210, or the like, for executing a proactive protection protocol. The protection circuitry 210 may execute a proactive protection protocol to provide overdraft protection for the legacy payment account. In particular, as described in further detail in FIG. 5, the protection circuitry 210 may execute the proactive protection protocol, which includes a series of automated operations, to ensure the continuity of recurring autopayment events during the transition from the legacy payment account to the new payment account.

In some embodiments, the proactive protection protocol may include operations that identify any unscheduled recurring autopayment events (e.g., recurring autopayment events derived from the legacy payment account but not transitioned to or scheduled in the new payment account), determine whether any unscheduled recurring autopayment events are associated with a deadline that occurs within a predefined threshold time period, and if so, whether the legacy payment account has sufficient funds to cover the upcoming payment. If the legacy payment account is determined not to have sufficient funds to cover the upcoming payment, the proactive action protocol may further include performing one or more proactive intervention operations to address the upcoming payment. In some embodiments, the proactive protection protocol may schedule any currently unscheduled recurring autopayment events as new recurring autopayment events in the new payment account. In some embodiments, the proactive protection protocol may further verify one or more scheduled recurring autopayment events. Furthermore, in some embodiments, the proactive action protocol may schedule a temporary recurring digital payment from the new payment account to the legacy payment account.

In some embodiments, operation 306 may be performed in accordance with the operations described by FIG. 5. Turning now to FIG. 5, example operations are shown for executing the proactive protection protocol.

As shown by operation 502, the apparatus 200 includes means, such as the protection circuitry 210 or the like, for analyzing a new payment account of the user to determine whether each recurring autopayment event corresponds to a scheduled recurring autopayment event in the new payment account. The protection circuitry 210 may identify the derived set of recurring autopayment events that include the one or more derived recurring autopayment events (e.g., from the legacy payment account). The protection circuitry 210 may cross-reference each derived recurring autopayment event with the scheduled recurring autopayment events currently configured in the new payment account. In particular, the protection circuitry 210 may compare parameters between a derived recurring autopayment event and a scheduled recurring autopayment event and, based on this comparison, determine whether the derived recurring autopayment event sufficiently corresponds to a scheduled recurring autopayment event. The protection circuitry 210 may determine the derived recurring autopayment event corresponds to a scheduled recurring autopayment event if the parameter values of the derived recurring autopayment event sufficiently correspond to a scheduled recurring autopayment event. Otherwise, the protection circuitry 210 may determine the derived recurring autopayment event is an unscheduled recurring autopayment event. If there are no unscheduled recurring autopayment events, the process may proceed directly to operation 512. Otherwise, the process proceeds to operation 504.

The protection circuitry 210 may cross-reference a derived recurring autopayment event with a scheduled recurring autopayment event using the associated parameters of both. In particular, the protection circuitry 210 may compare similar parameters, such as the payee identifier and/or payee name of both events. The protection circuitry 210 may also compare the average payment amount for a derived recurring autopayment event and a scheduled amount for a scheduled recurring autopayment event. The protection circuitry 210 may also compare the predicted upcoming payment date for the derived recurring autopayment event and a scheduled payment date for the scheduled recurring autopayment event. To handle variations in payment details, particularly in the payee name, the protection circuitry 210 may use normalization and/or fuzzy matching techniques. Thus, minor differences in payee name, such as “Util. Comp. X” and “Utility Company X,” are accounted for. Additionally, the protection circuitry 210 may allow for variations in payment dates and/or payment amounts to account for variations. For example, the protection circuitry 210 may allow for payment amount variations within a predefined payment threshold (e.g., within 5%) and/or allow for payment date variations within a predefined date threshold (e.g., within three days of one another).

As shown by operation 504, the apparatus 200 includes means, such as the protection circuitry 210 or the like, for evaluating whether a deadline associated with an unscheduled recurring autopayment event falls within a predefined threshold time period. The protection circuitry 210 may evaluate whether a deadline for an unscheduled recurring autopayment event is upcoming and within a predefined threshold time period. This may indicate that the protection circuitry 210 needs to prioritize the unscheduled recurring autopayment event. In some embodiments, the protection circuitry 210 may determine the deadline using the parameters of the unscheduled recurring autopayment event (e.g., as determined for the derived recurring autopayment event). In some embodiments, the protection circuitry 210 may use the predicted upcoming payment date parameter value as the deadline. The protection circuitry 210 may then determine whether the predicted upcoming payment date falls within a threshold time period (e.g., within the next day, the next three days, the next week, or the like). If so, the protection circuitry 210 may perform additional operations to ensure the legacy payment account does not experience an overdraft. If no unscheduled recurring autopayment events are determined to have a deadline within the threshold period of time, the process may proceed directly to operation 510. Otherwise, the process proceeds to operation 506.

As shown by operation 506, the apparatus 200 includes means, such as the memory 204, the communications hardware 206, the protection circuitry 210, or the like, for assessing whether the legacy payment account has sufficient funds to satisfy an upcoming payment associated with an unscheduled recurring autopayment event. The protection circuitry 210 may ensure that the legacy payment account has sufficient funds to cover the financial obligations that remain linked to the legacy payment account. The protection circuitry 210 may determine the upcoming payment amount using the parameters of the unscheduled recurring autopayment event. In particular, the protection circuitry 210 may use the average payment amount for the unscheduled recurring autopayment event (e.g., as determined for the derived recurring autopayment event) as the upcoming payment amount.

In some embodiments, the protection circuitry 210 may retrieve a token from an associated memory, such as the memory 204, and use the token to access a current account balance of the legacy payment account. As described in operation 402 of FIG. 4, in some embodiments, a user may opt to allow the apparatus 200 long-term access to and/or use of the legacy payment account. If this option was selected, the token received from an entity device (e.g., any one of entity devices 110A-110N), which was stored in the memory 204, may be used again to access the current account balance of the legacy payment account. Thus, the protection circuitry 210 may cause the communications hardware 206 to provide the corresponding token along with a request for the current account balance to an entity device (e.g., any one of entity devices 110A-110N) associated with the legacy payment account. The communications hardware 206 may perform this request using an API service. If the user opted not to provide long-term access to the legacy payment account, the protection circuitry 210 may cause the communications hardware 206 to prompt the user via a user device (e.g., any one of user devices 106A-106N) to provide the legacy payment account credentials to access the legacy payment account again, in a substantially similar manner as described in operation 402 of FIG. 4. Once the user has provided the legacy payment account credentials, the communications hardware 206 may then provide the request to the entity device (e.g., any one of entity devices 110A-110N) using the API service and may include the provided legacy payment account credentials in the request. The entity device (e.g., any one of entity devices 110A-110N) may then authenticate the provided token or the provided legacy payment account credentials. If successfully authenticated, the communications hardware 206 may receive a response from the entity device that includes the current account balance of the legacy payment account. Otherwise, the user may be prompted to enter and/or reenter his/her legacy payment account credentials. If the entity device is unable to authenticate a request after a threshold number of times (e.g., three attempts), the protection circuitry 210 may provide an amount request to a user device (e.g., any one of user devices 106A-106N). The amount request may request that the user manually enter the current account balance of the legacy payment account. The communications hardware 206 may receive a response that includes the user input current account balance and provide this to the protection circuitry 210.

Once the protection circuitry 210 has determined the current account balance of the legacy payment account, the protection circuitry 210 may determine whether the current account balance is sufficient to satisfy the upcoming payment. In particular, the protection circuitry 210 may determine whether the current account balance is sufficient to satisfy the average payment amount. In some embodiments, the protection circuitry 210 may determine that the legacy payment account has sufficient funds if the current account balance is equal to or exceeds the average payment amount. In some embodiments, the protection circuitry 210 may determine that the legacy payment account has sufficient funds if the current account balance exceeds the average payment amount and the remaining account balance is equal to or exceeds an account balance threshold. That is, the protection circuitry 210 may consider that legacy payment accounts require a minimum account balance to avoid penalties and/or fees. Thus, the protection circuitry 210 may ensure the account balance of the legacy payment account remains at or above the minimum account balance to avoid such penalties. If the legacy payment account is determined to have sufficient funds for each unscheduled recurring autopayment event associated with an upcoming deadline, the process may proceed directly to operation 510. Otherwise, the process proceeds to operation 508.

As shown by operation 508, the apparatus 200 includes means, such as the communications hardware 206, the protection circuitry 210, or the like, for performing a proactive intervention operation to address the upcoming payment. The protection circuitry 210 may perform one or more proactive intervention operations when it determines that the legacy payment account lacks sufficient funds to fulfill the payment. In doing so, automated corrective actions may be performed to ensure that financial obligations associated with the unscheduled recurring autopayment event are satisfied, thereby preventing overdrafts, fines, penalties, and/or service interruptions or cancellations for the user without manual intervention.

The proactive actions may include (a) providing a payment alert to the user, (b) transferring a fund amount sufficient to satisfy the upcoming payment associated with the unscheduled recurring autopayment event from the new payment account to the legacy payment account, and/or (c) triggering a payment from the new payment account to satisfy the upcoming payment associated with the unscheduled recurring autopayment event. In some embodiments, the protection circuitry 210 may determine which proactive action to perform based on default settings, user preference settings, and/or a payment alert response provided by the user. In some embodiments, the default settings may define and/or control the proactive operations that the protection circuitry 210 performs. For example, the default settings may require the protection circuitry 210 to provide the payment alert and transfer a fund amount to satisfy the upcoming payment. In some embodiments, the user may provide user preference settings for his/her new payment account. The user preference settings may control the proactive operations the protection circuitry 210 performs and, further, may override the default settings. In some embodiments, the user may interact with the payment alert to select and/or authorize a specific proactive action. The communications hardware 206 may receive a payment alert response from the user via a user device (e.g., any one of user devices 106A-106N). The protection circuitry 210 may then determine a proactive action to perform based on an authorized proactive action (e.g., transfer a fund amount sufficient to satisfy the upcoming payment associated with the unscheduled recurring autopayment event from the new payment account to the legacy payment account and/or trigger a payment from the new payment account to satisfy the upcoming payment associated with the unscheduled recurring autopayment event).

In some embodiments, the proactive action may include providing a payment alert to a user via a user device (e.g., any one of user devices 106A-106N). The protection circuitry 210 may generate the payment alert to inform the user of the impending payment for the unscheduled recurring autopayment event. The payment alert may include the parameters of the unscheduled recurring autopayment event, such as the payee identifier, payee name, the average payment amount, and the predicted upcoming payment date. The payment alert may further include a reason for the alert (e.g., an upcoming unscheduled recurring autopayment event and insufficient funds in the legacy payment account). In some embodiments, the payment alert may further provide actionable options for the user. For example, the payment alert may include user interactions that allow the user to authorize the protection circuitry 210 to authorize a fund transfer from the new payment account to the legacy payment account. As another example, the payment alert may allow the user to authorize the protection circuitry 210 to trigger a payment from the new payment account in satisfaction of the upcoming payment for the unscheduled recurring autopayment event. The protection circuitry 210 may cause the communications hardware 206 to provide the payment alert to the user via a user device (e.g., any one of user devices 106A-106N). The payment alert may be provided over one or more communication channels, such as over email, short message service, a push notification via an associated mobile application, and/or the like. The protection circuitry 210 may use phone numbers, email addresses, a device identifier, a registration identifier, and/or the like associated with the new payment account to provide the payment alert.

The protection circuitry 210 may determine to perform the transfer of the fund amount to ensure that the legacy payment account has sufficient funds to cover the upcoming payment for the unscheduled recurring autopayment event. In some embodiments, the protection circuitry 210 may determine the amount of funds needed to satisfy the upcoming payment associated with the unscheduled recurring autopayment event. For example, the protection circuitry 210 may use the average payment amount as the upcoming payment amount. The protection circuitry 210 may then determine a required fund amount based on the upcoming payment amount and the current account balance of the legacy payment account. For example, the legacy payment account may have a current account balance of $100.00 and the upcoming payment amount may be $120.00. Thus, the protection circuitry 210 may determine a required fund amount of $20.00. In some embodiments, the protection circuitry 210 may also consider penalties and/or fees for violating a minimum account balance for the legacy payment account. For example, the legacy payment account may have a current account balance of $100.00 and the upcoming payment amount may be $120.00. The legacy payment account may also have a minimum account balance threshold of $100.00. Thus, the protection circuitry 210 may determine a required fund amount of $120.00. The protection circuitry 210 may transfer the required fund amount using any suitable payment rail. In some embodiments, the protection circuitry 210 may use an automated clearing house (ACH) payment, wire transfer, real-time payment (RTP) payment platform, digital platform, and/or the like. For example, the protection circuitry 210 may use a digital transfer platform, such as Zelle®, which may allow for instantaneous transfer of funds from the new payment account to the legacy payment account. This may be particularly advantageous for time-sensitive unscheduled recurring autopayment events.

In some embodiments, the protection circuitry 210 may further confirm the success of the transfer by querying the current account balance of the legacy payment account. If the protection circuitry 210 determines the transfer has not succeeded, the protection circuitry 210 may retry the transfer. Thus, protection circuitry 210 may ensure that the required fund amount arrives in the legacy payment account in advance of the payment date, thus preventing the legacy payment account from experiencing an overdraft.

The protection circuitry 210 may determine to trigger a payment from the new payment account to satisfy the upcoming payment associated with the unscheduled recurring autopayment event. In some embodiments, the protection circuitry 210 may determine the amount of funds needed to satisfy the upcoming payment associated with the unscheduled recurring autopayment event. For example, the protection circuitry 210 may use the average payment amount as the upcoming payment amount. In some embodiments, the protection circuitry 210 may request a verified payment amount via communications hardware 206 from a payee device (e.g., any one of payee devices 108A-108N) of a payee system associated with the unscheduled recurring autopayment event. The protection circuitry 210 may use the received verified payment amount as the payment amount for the upcoming payment. In some embodiments, the protection circuitry 210 may further determine user account details for the relevant unscheduled recurring autopayment event based on the associated historical transactions. In some embodiments, the protection circuitry 210 may use the user account identifier to identify an associated user account provided by a payee system associated with the unscheduled recurring autopayment event. For example, the user may have a user account identifier of “123456789” with Utility Company X. The protection circuitry 210 may use this user account identifier with the payment such that a payee device (e.g., any one of payee devices 108A-108N) may identify the user account for the user and allocate the received funds to the appropriate user account. The protection circuitry 210 may then trigger a transfer of funds for the payment amount using any suitable payment rail. In some embodiments, the protection circuitry 210 may use an ACH payment, wire transfer, RTP payment platform, digital platform, and/or the like. For example, the protection circuitry 210 may use a digital transfer platform, such as Zelle®, which may allow for instantaneous transfer of funds from the new payment account to the payee device (e.g., any one of payee devices 108A-108N). This may be particularly advantageous for time-sensitive unscheduled recurring autopayment events.

In some embodiments, the communications hardware 206 may receive a confirmation of successful payment processing from a payee device (e.g., any one of payee devices 108A-108N). The communications hardware 206 may provide this confirmation to the user via a user device (e.g., any one of user devices 106A-106N).

As shown by operation 510, the apparatus 200 includes means, such as the communications hardware 206, the protection circuitry 210, or the like, for scheduling any unscheduled recurring autopayment events as recurring autopayment events in the new payment account. The protection circuitry 210 may schedule the one or more unscheduled recurring autopayment events as recurring autopayment events in the new payment account. Thus, any unscheduled recurring autopayment event that remains tied to the legacy payment account is transferred to the new payment account without disruption and without requiring manual intervention.

The protection circuitry 210 may identify the one or more unscheduled recurring autopayment events as determined in operation 502. As described above, the parameters of an unscheduled recurring autopayment event may include a payee identifier, a payee name, an average payment amount, a payment frequency, a payment consistency category (e.g., consistent or varied payments), and/or a predicted upcoming payment date. The protection circuitry 210 may then generate a recurring autopayment event for the new payment account for an unscheduled recurring autopayment event. In some embodiments, the protection circuitry 210 may generate a recurring autopayment event within the new payment account and populate the parameters of the recurring autopayment event using the associated parameter values. The values of the parameters of the recurring autopayment event may control the details of the payment associated with the recurring autopayment event.

For example, an unscheduled recurring autopayment event may have values of “Service XYZ” for the payee name, “654321” for the payee identifier, $15.00 for the average payment amount, “monthly” for the payment frequency, a payment consistency category of “consistent,” and a value of Jun. 1, 2024, for the predicted upcoming payment date. The protection circuitry 210 may generate a recurring autopayment event in the new payment account with values of “654321” for a recipient parameter, “Service XYZ” for a recipient name parameter, $15.00 for a payment amount parameter, “monthly” for a frequency parameter, and Jun. 1, 2024, for a start date parameter. Thus, starting on Jun. 1, 2024, the recurring autopayment event may cause the apparatus 200 to transfer an amount of $15.00 to the 654321 account of Service XYZ, and this may continue in monthly increments (e.g., every first of the month) for the same payment amount of $15.00. In some embodiments, the protection circuitry 210 may further determine user account details for the relevant unscheduled recurring autopayment event based on the associated historical transactions. Additionally, the protection circuitry 210 may select a payment type of the recurring autopayment event. For example, a payment type may be an ACH payment, a wire transfer, via an RTP payment platform, via a digital platform, and/or the like. In some embodiments, the payment type may be selected based on user preferences associated with the new payment account.

The recurring autopayment event may further include the user account identifier. Thus, a payee device (e.g., any one of payee devices 108A-108N) may use the user account number to identify the user account for the user and allocate the received funds to the appropriate user account upon receipt of payment.

In some embodiments, the protection circuitry 210 may use an API service to set up a recurring payment event. This may be required if the unscheduled recurring autopayment event does not include a payee identifier, which can be used to transfer funds directly to the payee. In some embodiments, the protection circuitry 210 may use the communications hardware 206 to establish a connection with a payee device (e.g., any one of payee devices 108A-108N) of the payee associated with the unscheduled recurring payment event. The communications hardware 206 may use the API service to establish a link between the new payment account and the payee system to allow for funds to be transferred from the new payment account to the payee system. In some embodiments, the user may need to provide his/her user account credentials via a user device (e.g., any one of user devices 106A-106N) to authorize the link to be established and/or permit user account changes. In some embodiments, the communications hardware 206 may provide the account details of the new payment account to the payee device (e.g., any one of payee devices 108A-108N), and the payee device may update the corresponding user account to reflect the change to the new payment account details. This causes the new payment account to be charged rather than the legacy payment account.

As shown by operation 512, the apparatus 200 includes means, such as the communications hardware 206, the protection circuitry 210, or the like, for verifying a scheduled recurring autopayment event. In some embodiments, the protection circuitry 210 may verify a scheduled recurring autopayment event to ensure that the parameters of the scheduled recurring autopayment event are correct and that scheduled payments can be executed without error, delay, or rejection. This may be particularly important for recurring autopayment events that were scheduled manually or without the use of an API service that links the new payment account and the payee system and/or payee device (e.g., any one of payee devices 108A-108N).

In some embodiments, the protection circuitry 210 may initiate a test transaction with a payee device (e.g., any one of payee devices 108A-108N) to ensure compatibility with the payee system. For example, the protection circuitry 210 may initiate a test transaction with a payee device (e.g., any one of payee devices 108A-108N) for a nominal amount (e.g., $0.01) from the new payment account. The protection circuitry 210 may use the parameter values from the scheduled recurring autopay event for the test transaction. By way of continuing example, the protection circuitry 210 may initiate a test transaction using “654321” for the recipient. The communications hardware 206 may receive a confirmation message from the payee device that is indicative of whether the payment was successfully received and processed or whether there was an error in the processing. If the confirmation message indicates the payment was successful, the scheduled recurring autopayment event may be successfully verified. Otherwise, the scheduled recurring autopayment event may not be verified and, instead, may be flagged for review by the user. In some embodiments, a verification status parameter may be included for a scheduled recurring autopayment event. The verification status parameter may be indicative of whether the scheduled recurring autopayment event was successfully verified. For example, a scheduled recurring autopayment event that has been successfully verified may be associated with a verification status of “verified.” As another example, a scheduled recurring autopayment event that has failed verification may be associated with a verification status of “unverified.” As another example, a scheduled recurring autopayment event for which no verification operation has been performed yet may be associated with a verification status of “pending.”

As shown by operation 514, the apparatus 200 includes means, such as the protection circuitry 210 or the like, for scheduling a temporary recurring digital payment from the new payment account to the legacy payment account. In some embodiments, a temporary recurring digital payment to the legacy payment account may ensure that any missed recurring payments linked to the legacy payment account can still be fulfilled during the transition to the new payment account.

In some embodiments, the protection circuitry 210 may determine a safety fund amount for the legacy payment account. The safety fund amount may be a fund amount that is transferred from the new payment account to the legacy payment account to cover any unexpected charges and/or as a failsafe in case newly scheduled and/or unverified scheduled recurring autopayment events remain linked to the legacy payment account. The safety fund amount may be set manually by the user via a user device (e.g., any one of user devices 106A-106N). Thus, the user may control the safety fund amount that is deposited. Additionally, or alternatively, the user may manually select the payment frequency of the temporary recurring digital payment, a payment duration, and/or a start date. For example, the user may log into the new payment account via a user device (e.g., any one of user devices 106A-106N) and select a safety fund amount of $100.00, a payment frequency of biweekly, a duration of two months, and a start date of Jun. 15, 2024. Thus, the new payment account may schedule a temporary recurring digital payment starting on Jun. 15, 2024, for the amount of $100.00 every two weeks for the next two months.

Alternatively, the protection circuitry 210 may automatically determine a safety fund amount for the legacy payment account without manual intervention. In some embodiments, the protection circuitry 210 may determine the safety fund amount based on the number of unverified scheduled recurring autopayment events for the new payment account, the current account balance of the legacy payment account, an average payment amount for each unverified scheduled recurring autopayment event, a payment frequency for each unverified scheduled recurring autopayment event, and/or a predicted upcoming payment date for each unverified scheduled recurring autopayment event. The protection circuitry 210 may perform any mathematical and/or logical operations to determine parameters for the temporary recurring digital payment.

For example, the protection circuitry 210 may determine there are ten scheduled recurring autopayment events in the new payment account. The protection circuitry 210 may determine that seven of the ten scheduled recurring autopayment events are verified, and thus, there are three unverified scheduled recurring autopayment events. A first unverified scheduled recurring autopayment event may include parameter values of $25.00 for the average payment amount, “monthly” for payment frequency, and a predicted upcoming payment date of Nov. 6, 2024. A second unverified scheduled recurring autopayment event may include parameter values of $110.00 for the average payment amount, “monthly” for payment frequency, and a predicted upcoming payment date of Nov. 8, 2024. A third unverified scheduled recurring autopayment event may include parameter values of $150.00 for the average payment amount, “monthly” for payment frequency, and a predicted upcoming payment date of Nov. 18, 2024. The protection circuitry 210 may determine that the legacy payment account currently has an account balance of $125.00 and has a minimum account balance requirement of $100.00. The protection circuitry 210 may determine to schedule a temporary recurring autopayment starting on Nov. 4, 2024, for the amount of $260.00 every month for the next six months. Thus, the funds from the temporary recurring autopayment may arrive at the legacy payment account in advance of the unverified scheduled recurring autopayment events and may provide the funds necessary to maintain the minimum account balance requirement should all the unverified scheduled recurring autopayment events remain linked to the legacy payment account.

In some embodiments, the protection circuitry 210 may adjust the parameters of the temporary recurring digital payment based on the current account balance of the legacy payment account and whether the unverified scheduled recurring autopayment events were successfully performed with the new payment account. If an unverified scheduled recurring autopayment event was successfully performed with the new payment account, the protection circuitry 210 may verify the corresponding scheduled recurring autopayment event. Thus, the temporary recurring digital payment no longer needs to provide funds to cover the now verified scheduled recurring autopayment event and the protection circuitry 210 may adjust the safety fund amount accordingly.

In some embodiments, the protection circuitry 210 may additionally adjust the parameters of the temporary recurring digital payment based on the current account balance of the legacy payment account. In some embodiments, the protection circuitry 210 may use the communications hardware 206 to query a current account balance of the legacy payment account. The protection circuitry 210 may then adjust the safety fund amount accordingly. For example, a first unverified scheduled recurring autopayment event may have an average payment amount of $150.00 and a second unverified scheduled recurring autopayment event may have an average payment amount of $110.00. The legacy payment account may have a current account balance of $500.00 and a minimum balance requirement of $100.00. Here, the protection circuitry 210 may determine a safety fund amount of $0.00. If a safety fund amount is $0.00, the protection circuitry 210 may cause the temporary recurring digital payment to be skipped for the scheduled time slot. The protection circuitry 210 may query the current account balance of the legacy payment account prior to the next scheduled time slot for the temporary recurring digital payment and may readjust the temporary recurring digital payment accordingly.

Once the temporary recurring digital payment has been over the duration, the temporary recurring digital payment may expire, and therefore, the safety fund amount may no longer be provided to the legacy payment account. In some embodiments, the protection circuitry 210 may renew the temporary digital payment if a scheduled recurring autopayment remains unverified.

In some embodiments, the temporary recurring digital payment may be configured to automatically terminate upon detection that all recurring autopayment events have successfully been transitioned to the new payment account. If the protection circuitry 210 determines that each recurring autopayment event has been successfully scheduled in the new payment account, it may determine that all recurring autopayment events have successfully been transitioned to the new payment account. In some embodiments, the protection circuitry 210 may determine that all recurring autopayment events have successfully been transitioned to the new payment account if each recurring autopayment event is scheduled in the new payment account and if each recurring autopayment event has been successfully verified. The protection circuitry 210 may immediately terminate the temporary recurring digital payment upon determining all recurring autopayment events have been satisfied. Thus, even if the temporary recurring digital payment has a remaining duration, the protection circuitry 210 may cause the temporary recurring digital payment to be cancelled and/or terminated.

The protection circuitry 210 may cause a notification to be provided to a user device (e.g., any one of user devices 106A-106N) in advance of a temporary recurring digital payment, and the user may manually adjust any parameters and/or cancel the temporary recurring digital payment if he/she so chooses. The protection circuitry 210 may also cause a notification to be provided to a user device (e.g., any one of user devices 106A-106N) once a temporary recurring digital payment has been sent to the legacy payment account.

Returning now to FIG. 3, as shown by operation 308, the apparatus 200 includes means, such as the communications hardware 206, the visualization circuitry 212, or the like, for generating a transition summary dashboard. A transition summary dashboard may be an interactive, user-friendly interface that provides an overview of the recurring autopayment events derived from the legacy payment account and a status and/or progress of transitioning each recurring autopayment event from the legacy payment account to the new payment account. The transition summary dashboard may be accessible from the user's new payment account, which may be accessed via a user device (e.g., any one of user devices 106A-106N) upon successful authorization of provided user credentials. In some embodiments, the communications hardware 206 may provide the transition summary dashboard to a user device (e.g., any one of user devices 106A-106N) upon successful authentication of user-provided user credentials.

In particular, the visualization circuitry 212 may generate the transition summary dashboard to include a progress overview that is indicative of various metrics pertaining to the transition of recurring autopayment events derived from the legacy payment account. In some embodiments, the transition summary dashboard may provide an overview of the number of recurring autopayment events derived from the legacy payment account, the number of recurring autopayment events currently scheduled in the new payment account, the number of recurring autopayment events currently unscheduled in the new payment account, the number of scheduled recurring autopayment events that are currently verified, the number of scheduled recurring autopayment events that are currently unverified, and/or the like.

In some embodiments, the visualization circuitry 212 may generate the transition summary dashboard to include an overview of the parameters pertaining to each derived recurring autopayment event. In some embodiments, each recurring autopayment event may include an indication of the associated payee name, an average payment amount, a payment amount, whether the recurring autopayment event has consistent or varied payment amounts, payment frequency, a predicted upcoming payment date, an indication of whether the recurring autopayment event is currently scheduled in the new payment account, an indication of whether the scheduled recurring autopayment event has been successfully verified, and/or the like. In some embodiments, the transition summary dashboard may further include one or more user interaction elements that allow the user to modify the recurring autopayment event. For example, a user interaction element may allow a user to modify or edit one or more parameters of a recurring autopayment event. As another example, a user interaction element may allow a user to cancel a recurring autopayment event. In some embodiments, the transition summary dashboard may further include a user interaction element that allows a user to create a new recurring autopayment event in the new payment account.

In some embodiments, the visualization circuitry 212 may generate the transition summary dashboard to include an overview of the parameters pertaining to a temporary recurring digital payment. In some embodiments, a temporary recurring digital payment to the legacy payment account may include a legacy payment account identifier, a safety fund amount, a payment date, a payment frequency, a remaining duration for the temporary recurring digital payment, and/or the like. In some embodiments, the transition summary dashboard may further include one or more user interaction elements that allow the user to modify the temporary recurring digital payment. For example, a user interaction element may allow a user to modify or edit one or more parameters of a temporary recurring digital payment. As another example, a user interaction element may allow a user to cancel a temporary recurring digital payment. In some embodiments, the transition summary dashboard may further include a user interaction element that allows a user to create a new temporary recurring digital payment for the new payment account.

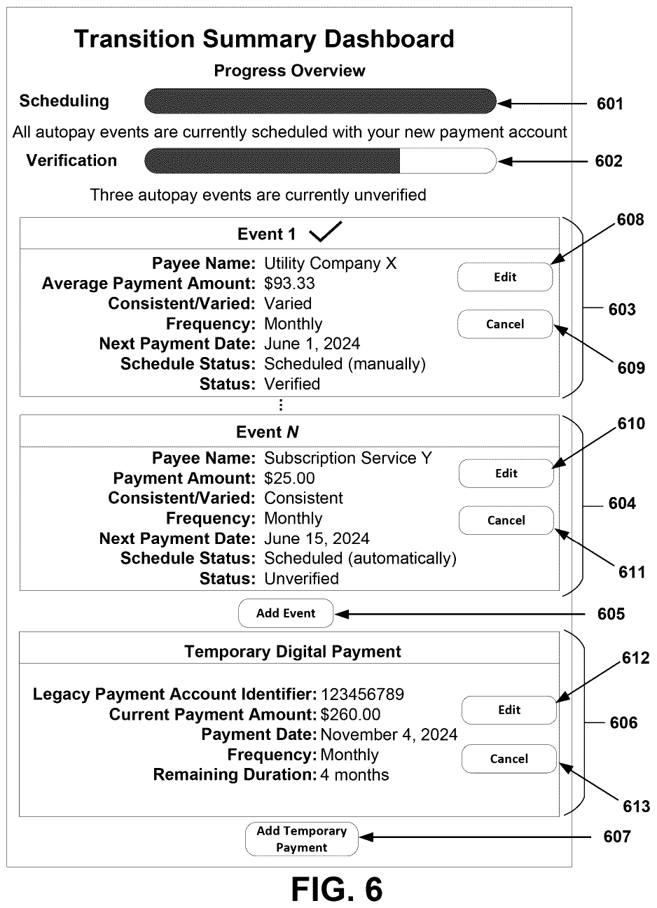

Turning to FIG. 6, a GUI is provided that illustrates an example transition summary dashboard. As noted previously, a user may interact with the proactive protection system 102 by directly engaging with the communications hardware 206 of an apparatus 200. In such an embodiment, the GUI shown in FIG. 6 may be displayed to a user by the apparatus 200. Alternatively, a user may interact with the proactive protection system 102 using a separate user device (e.g., any one of user devices 106A-106N, as shown in FIG. 1), which may communicate with the proactive protection system 102 via the communications network 104. In such an embodiment, the GUI shown in FIG. 6 may be displayed to the user by the user device.

As shown in FIG. 6, a transition summary dashboard may include a progress overview pertaining to the transition of recurring autopayment events derived from the legacy payment account. In particular, a scheduling progress overview bar 601 may visually depict number of recurring autopayment events currently scheduled and/or unscheduled in the new payment account. A verification progress overview bar 602 may visually depict the number of scheduled recurring autopayment events that are verified and/or unverified. Additionally, the transition summary dashboard may include event summaries for each recurring autopayment event derived from the legacy payment account. For example, a first event summary 603 may provide an overview of the parameters associated with a first derived recurring autopayment event, and a final event summary 604 may provide an overview of the parameters associated with a final derived recurring autopayment event. Each event summary may further include one or more user interaction elements that allow the user to modify a corresponding recurring autopayment event. For example, user interaction element 608 may allow a user to modify the first derived recurring autopayment event, and user interaction element 609 may allow a user to cancel the first derived recurring autopayment event. As another example, user interaction element 610 may allow a user to modify the final derived recurring autopayment event, and user interaction element 611 may allow a user to cancel the final derived recurring autopayment event. User interaction element 605 may allow a user to create a new recurring autopayment event.

Additionally, the transition summary dashboard may include a summary of temporary digital payments. For example, the temporary digital payment summary 606 provides an overview of the parameters associated with a first temporary digital payment. User interaction element 608 may allow a user to modify the first derived recurring autopayment event, and user interaction element 609 may allow a user to cancel the first derived recurring autopayment event. Each temporary digital payment summary may further include one or more user interaction elements that allow the user to modify a corresponding temporary digital payment. For example, user interaction element 612 may allow a user to modify the first temporary recurring digital payment, and user interaction element 613 may allow a user to cancel the first temporary recurring digital payment. User interaction element 607 may allow a user to create a new temporary recurring digital payment.

Returning now to FIG. 3, as shown by operation 310, the apparatus 200 includes means, such as the protection circuitry 210 or the like, for monitoring the new payment account and/or legacy payment account for a watch period. In some embodiments, the protection circuitry 210 may monitor the activity in the new payment account over a watch period to ensure that recurring autopayment events are functioning as intended. This monitoring may be performed autonomously and may allow the apparatus 200 to detect and address any issues that arise during the transition from the legacy payment account.

A watch period may refer to a predefined time over which the protection circuitry 210 will monitor the new payment account. For example, the watch period may be 30 days, 60 days, 90 days, six months, one year, etc. In some embodiments, the watch period may refer to a time period that runs until a trigger event occurs. For example, a trigger event may be scheduling each derived recurring autopayment event in the new payment account and/or successful verification of each scheduled recurring autopayment event.

In some embodiments, the protection circuitry 210 may monitor the new payment account by determining whether each scheduled recurring autopayment event is successfully executed. In some embodiments, the communications hardware 206 may receive a successful payment confirmation receipt from a payee device (e.g., any one of payee devices 108A-108N) associated with the payee system. The protection circuitry 210 may use the payment confirmation receipts to determine whether a scheduled recurring autopayment event is successful.

In some embodiments, the protection circuitry 210 may leverage the communications hardware 206 to request and/or retrieve an updated set of payment statements from the legacy payment account during the watch period. The communications hardware 206 may retrieve the set of historical transactions in a similar manner as described in FIG. 4. The analysis circuitry 208 may perform similar operations as described in FIG. 4 to generate a new set of historical transactions. Additionally, the protection circuitry 210 may analyze the new set of historical transactions separately and/or with the original set of historical transactions in a similar manner, as described in operation 304, to derive additional recurring autopayment events. In this way, the protection circuitry 210 may catch irregular or less-frequently occurring recurring autopayment events. The protection circuitry 210 may execute a proactive protection protocol for any newly derived recurring autopayment events in a similar manner as described in operation 306.

It will be appreciated that although the above operations describe a single legacy payment account, embodiments described herein may be contemplated for multiple legacy payment accounts.

FIGS. 4-6 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special-purpose, hardware-based computing devices that perform the specified functions or combinations of special-purpose hardware and software instructions.

### Conclusion

As described above, example embodiments provide methods and apparatuses that provide improved automatic transitioning of recurring autopayment events between payment accounts. Example embodiments avoid the need for users to manually transition recurring autopayment events between payment accounts, thus conserving time as well as manual and computational resources. Furthermore, example embodiments automatically schedule recurring autopayment events with a new payment account using attributes of historical transactions associated with the corresponding recurring autopayment event. This results in improved accuracy and efficiency by ensuring the parameters of scheduled recurring autopayment events are accurate, thereby avoiding unnecessary delays due to manual entry errors. Example embodiments optimize the efficiency of computational systems by reducing redundant tasks, minimizing the risk of processing errors, and enhancing system performance by proactively identifying and resolving issues with recurring autopayment events.

Moreover, example embodiments contemplated herein provide technical solutions that solve real-world problems faced by users who wish to seamlessly transition to a new payment account. The rise of subscription-based services and the widespread adoption of autopayments have made recurring autopayment events an integral part of everyday life. As users increasingly rely on recurring autopayment events to handle their financial obligations, ensuring a seamless transition of these events to a new payment account is more important than ever. By automatically handling the transition of recurring autopayments into the new payment account, example embodiments alleviate user burden, prevent payment disruptions, and deliver faster/more reliable scheduling operations.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for autonomously providing overdraft protection during transitions between payment accounts, the method comprising:
identifying, by analysis circuitry, a set of historical transactions associated with a legacy payment account of a user;
deriving, by the analysis circuitry, a set of recurring autopayment events from the set of historical transactions; and
executing, by protection circuitry, a proactive protection protocol, the proactive protection protocol comprising:
analyzing, by the protection circuitry, a new payment account of the user to determine whether each recurring autopayment event from the set of recurring autopayment events corresponds to a scheduled recurring autopayment event in the new payment account,
in response to detecting an unscheduled recurring autopayment event, evaluating, by the protection circuitry, whether a deadline associated with the unscheduled recurring autopayment event falls within a predefined threshold time period,
in response to detecting that the deadline falls within the predefined threshold time period, assessing, by the protection circuitry, whether the legacy payment account has sufficient funds to satisfy an upcoming payment associated with the unscheduled recurring autopayment event,
in response to determining the legacy payment account does not have sufficient funds, performing, automatically, by the protection circuitry, a proactive intervention operation to address the upcoming payment,
scheduling, automatically, by the protection circuitry, any unscheduled recurring autopayment events as recurring autopayment events in the new payment account, and
scheduling, automatically, by the protection circuitry, a temporary recurring digital payment from the new payment account to the legacy payment account.

2. The method of claim 1, wherein performing the proactive intervention operation comprises at least one of:
causing, by the protection circuitry, provision of a payment alert to the user;
transferring, by the protection circuitry, a fund amount sufficient to satisfy the upcoming payment associated with the unscheduled recurring autopayment event from the new payment account to the legacy payment account; and
triggering, by the protection circuitry, a payment from the new payment account to satisfy the upcoming payment associated with the unscheduled recurring autopayment event.

3. The method of claim 1, wherein the temporary recurring digital payment is configured to automatically terminate upon detection that all recurring autopayment events have successfully been transitioned to the new payment account.

4. The method of claim 1, further comprising:
receiving, by communications hardware, a set of payment statements associated with the legacy payment account; and
extracting, by the analysis circuitry, individual historical transactions from the set of payment statements, wherein (a) each individual historical transaction is associated with a value for one or more transaction attributes, (b) a transaction attribute comprises at least one of a transaction date, a payment amount, a payee identifier, and a transaction description, and (c) the set of historical transactions include the individual historical transactions.

5. The method of claim 1, further comprising, verifying, by the protection circuitry, a scheduled recurring autopayment event with an associated payee system.

6. The method of claim 1, further comprising monitoring, by the protection circuitry, at least one of the new payment account and the legacy payment account for a watch period.

7. The method of claim 1, further comprising generating, by visualization circuitry, a transition summary dashboard comprising a visual summary of the set of recurring autopayment events and an indication of whether a corresponding temporary recurring digital payment has been scheduled and verified for each recurring autopayment event.

8. An apparatus for autonomously providing overdraft protection during transitions between payment accounts, the apparatus comprising:
analysis circuitry configured to:
identify a set of historical transactions associated with a legacy payment account of a user, and
derive a set of recurring autopayment events from the set of historical transactions; and
protection circuitry configured to execute a proactive protection protocol, wherein the protection circuitry is configured to perform the proactive protection protocol by:
analyzing a new payment account of the user to determine whether each recurring autopayment event from the set of recurring autopayment events corresponds to a scheduled recurring autopayment event in the new payment account,
in response to detecting an unscheduled recurring autopayment event, evaluating whether a deadline associated with the unscheduled recurring autopayment event falls within a predefined threshold time period,
in response to detecting that the deadline falls within the predefined threshold time period, assessing whether the legacy payment account has sufficient funds to satisfy an upcoming payment associated with the unscheduled recurring autopayment event,
in response to determining the legacy payment account does not have sufficient funds, performing, automatically, a proactive intervention operation to address the upcoming payment,
scheduling, automatically, any unscheduled recurring autopayment events as recurring autopayment events in the new payment account, and
scheduling, automatically, a temporary recurring digital payment from the new payment account to the legacy payment account.

9. The apparatus of claim 8, wherein proactive protection circuitry is configured to perform at least one of:
causing provision of a payment alert to the user;
transferring a fund amount sufficient to satisfy the upcoming payment associated with the unscheduled recurring autopayment event from the new payment account to the legacy payment account; and
triggering a payment from the new payment account to satisfy the upcoming payment associated with the unscheduled recurring autopayment event.

10. The apparatus of claim 8, wherein the temporary recurring digital payment is configured to automatically terminate upon detection that all recurring autopayment events have successfully been transitioned to the new payment account.

11. The apparatus of claim 8, wherein the apparatus further comprises communications hardware configured to receive a set of payment statements associated with the legacy payment account,
wherein the analysis circuitry is further configured to extract individual historical transactions from the set of payment statements, wherein (a) each individual historical transaction is associated with a value for one or more transaction attributes, (b) a transaction attribute comprises at least one of a transaction date, a payment amount, a payee identifier, and a transaction description, and (c) the set of historical transactions include the individual historical transactions.

12. The apparatus of claim 8, wherein the protection circuitry is further configured to verify a scheduled recurring autopayment event with an associated payee system.

13. The apparatus of claim 8, wherein the protection circuitry is further configured to monitor at least one of the new payment account and the legacy payment account for a watch period.

14. The apparatus of claim 8, wherein the apparatus further comprises visualization circuitry configured to generate a transition summary dashboard comprising a visual summary of the set of recurring autopayment events and an indication of whether a corresponding temporary recurring digital payment has been scheduled and verified for each recurring autopayment event.

15. A computer program product for autonomously providing overdraft protection during transitions between payment accounts, the computer program product comprising at least one non-transitory computer-readable storage medium storing software instructions that, when executed, cause an apparatus to:
identify a set of historical transactions associated with a legacy payment account of a user;
derive a set of recurring autopayment events from the set of historical transactions; and
execute a proactive protection protocol, the proactive protection protocol comprising:
analyzing a new payment account of the user to determine whether each recurring autopayment event from the set of recurring autopayment events corresponds to a scheduled recurring autopayment event in the new payment account,
in response to detecting an unscheduled recurring autopayment event, evaluating whether a deadline associated with the unscheduled recurring autopayment event falls within a predefined threshold time period,
in response to detecting that the deadline falls within the predefined threshold time period, assessing whether the legacy payment account has sufficient funds to satisfy an upcoming payment associated with the unscheduled recurring autopayment event,
in response to determining the legacy payment account does not have sufficient funds, performing, automatically, a proactive intervention operation to address the upcoming payment,
scheduling, automatically, any unscheduled recurring autopayment events as recurring autopayment events in the new payment account, and
scheduling, automatically, a temporary recurring digital payment from the new payment account to the legacy payment account.

16. The computer program product of claim 15, wherein the software instructions, when executed, are further configured to cause the apparatus to perform at least one of:
cause provision of a payment alert to the user;
transfer a fund amount sufficient to satisfy the upcoming payment associated with the unscheduled recurring autopayment event from the new payment account to the legacy payment account; and
trigger a payment from the new payment account to satisfy the upcoming payment associated with the unscheduled recurring autopayment event.

17. The computer program product of claim 15, wherein the temporary recurring digital payment is configured to automatically terminate upon detection that all recurring autopayment events have successfully been transitioned to the new payment account.

18. The computer program product of claim 15, wherein the software instructions, when executed, further cause the apparatus to:
receive a set of payment statements associated with the legacy payment account; and
extract individual historical transactions from the set of payment statements, wherein (a) each individual historical transaction is associated with a value for one or more transaction attributes, (b) a transaction attribute comprises at least one of a transaction date, a payment amount, a payee identifier, and a transaction description, and (c) the set of historical transactions include the individual historical transactions.

19. The computer program product of claim 15, wherein the software instructions, when executed, further cause the apparatus to verify a compatibility of the new payment account with a payee system associated with a scheduled recurring autopayment event.

20. The computer program product of claim 15, wherein the software instructions, when executed, further cause the apparatus to monitor at least one of the new payment account and the legacy payment account for a watch period.
